(19) United States
(12) Patent Application Publication
(10) Pub. No.: US 2005/0066226 A1
(43) Pub. Date: Mar. 24, 2005

(54) Redundant memory self-test

(76) Inventors: R. Dean Adams, St. George, VT (US); Eric W. MacDonald, El Paso, TX (US)

Correspondence Address: ROPES & GRAY LLP, ONE INTERNATIONAL PLACE, BOSTON, MA, 02110-2624, US

(21) Appl. No.: 10/668,651

(22) Filed: Sep. 23, 2003

(51) Int. Cl. G06F 11/00

(52) U.S. Cl. 714/7

(57) ABSTRACT

A built-in-self-test circuit selectively couples memory outputs to fault detection circuitry during a self-test, thereby reducing the size of fault detection circuitry and storage required to properly test and repair a memory with multi-dimensional redundancy. The circuit may store information concerning memory elements having the greatest number of faults and select these for replacement prior to addressing redundancy in another dimension. Redundancy may then be allocated in the other dimension to repair any remaining faults. When a memory element, such as a column, has a greater number of fails than the number of perpendicular redundant elements, the memory element may be identified for immediate replacement.

### FIELD OF INVENTION

This invention relates to self-test circuits for redundant memories, and more specifically to the calculation of redundancy implementation for those memory circuits.

### BACKGROUND OF THE INVENTION

Integrated circuit memories may be complex, and tend to be among the densest forms of semiconductor structures. Memories may be stand-alone packaged devices, or may be embedded on logic, system on chip (SOC), or processor chips. The amount of memory on non-memory chips grows every year and may become the dominant feature of semiconductor chips.

Manufacturing lines for integrated circuits are inherently imperfect, and will invariably introduce defects into circuits etched onto a silicon wafer. As memories become larger, the shear amount of circuitry presents an increasing probability that each memory circuit will contain one or more of these defects. The density and distribution of manufacturing defects across a silicon wafer may cause a high percentage of memory circuits to have defects present while the remainder of the chip is perfectly good. To address these good semiconductor chips with defective memories and enhance chip yield, the concept of spare memory elements was developed. The spare memory elements are normally in the form of extra rows or columns of memory cells broadly referred to as “redundancy.”

Built-in self-test (BIST) logic has emerged as a technique for testing chips with embedded memories. This BIST logic resides on the chip, and provides stimulus to the memory in the form of various test patterns selected to detect known manufacturing defects. The BIST logic may also examine the memory outputs to evaluate whether the circuitry is functioning properly in response to the provided test pattern. For a memory without redundancy, the detection of a failure means that the chip must be discarded. For a memory with redundancy, the redundant elements may be allocated to the defective memory location(s). For memories with multiple dimensions of redundancy, e.g. spare rows and columns, the self-test logic must make a decision whether to allocate a row or a column for each defective location.

Redundancy can be implemented at time of manufacture via “hard” implementation techniques. These techniques include allocating redundancy and then blowing the appropriate laser or electronic fuses. This fusing process associates the redundant element(s) with the defective memory locations from then on during the life of the chip. Redundancy can also be implemented via “soft” means where BIST is executed and redundancy is calculated at each power up of the chip. The soft redundancy calculation information is not retained once power is removed from the chip.

During test, if a single cell fail is encountered, either a spare row or a spare column can be utilized. If, however, a partial row or a partial column failure is encountered then a spare row or spare column, respectively, should be chosen for redundancy. The determination of whether to utilize a spare row or spare column is quite complicated in a BIST environment, since multiple cycle's pass/fail information needs to be accumulated before the appropriate redundancy dimension can be chosen.

For a stand alone memory chip, the whole memory may be tested with all of the failing locations identified by an external tester. Once all of the failing locations are identified the various redundancy solutions would be tried via software simulation means prior to implementing any of the redundancy in hardware. Often, all possible solutions are exercised prior to selecting the redundancy solution to implement. However, embedded memories may not be directly or conveniently accessible by an external tester.

In a BIST environment it is not practical to store all of the failing locations since a large memory may be required. Indeed, since BIST functions are ancillary to the purpose for which a chip is designed, very little space is typically allocated. Instead, the BIST logic must make a determination part way through the testing as to which redundant element dimension to utilize. Historically, several solutions have been employed.

One BIST environment solution is the arbitrary implementation of redundant elements. In this case, the first failure might have a row allocated to it with the next fail being replaced by a column, and so on. An arbitrary replacement scheme clearly would not lead to optimal redundancy repair since, for example a row failure might have a column arbitrarily allocated to a failed element in the row, which would fail to repair the entire row. More generally an arbitrary scheme may fail to repair a chip that is in fact repairable with the existing redundancy. When non-optimal redundancy implementation techniques are utilized, the yield is diminished since chips which are fixable end up not being repaired. Viable redundancy solutions may be missed when applying a limited redundancy calculation algorithm to a limited amount of redundant elements.

Another BIST environment solution is to place a counter on each one of the columns and count the number of fails on each. Based on this fail count, the column with more fails than available redundant rows would be selected as a must-fix column redundancy repair. Then must-fix rows would be implemented. These redundancy calculations would be followed up by repairing remaining failures with any available spare columns and spare rows.

Other approaches to the allocation of redundant elements in a BIST environment have been tried. However, they generally suffer from excessive on-chip logic for the redundancy calculation, or a poor redundancy implementation determination, or a combination of both. There remains a need for a multi-dimensional redundancy calculation technique suitable for deployment in a BIST environment.

### SUMMARY OF INVENTION

A built-in-self-test circuit selectively couples memory outputs to fault detection circuitry during a self-test, thereby reducing the size of fault detection circuitry and storage required to properly test and repair a memory with multi-dimensional redundancy. The circuit may store information concerning memory elements having the greatest number of faults and select these for replacement prior to addressing redundancy in another dimension. Redundancy may then be allocated in the other dimension to repair any remaining faults. When a memory element, such as a column, has a greater number of fails than the number of perpendicular redundant elements, the memory element may be identified for immediate replacement.

### BRIEF DESCRIPTION OF THE DRAWINGS

The foregoing and other objects and advantages of the invention will be appreciated more fully from the following further description thereof, with reference to the accompanying drawings, wherein:

FIG. 1 is a block diagram illustrating the connections between an embedded memory and a memory self test system for calculating redundancy;

FIG. 2 is a logic diagram of a pass/fail comparator utilized in prior art to simultaneously test all data outs within a given memory word;

FIG. 3 shows a memory array composed of intersecting word lines and columns with a single redundant column displayed;

FIG. 4 shows a memory array with a redundant Input/Output;

FIG. 5 shows a memory array with a redundant word line illustrated;

FIG. 6 shows a memory array with a redundant word line and a redundant column included;

FIG. 7 shows a memory array with a redundant word line and a redundant I/O included;

FIG. 8 shows a memory array with a redundancy calculator; and

FIG. 9 is a flow chart showing how fail information may be stored for redundancy calculation.

Unless specifically indicated otherwise like numbers throughout the figures refer to like elements.

### DESCRIPTION OF THE PREFERRED EMBODIMENT

It will be appreciated that the term “memory element”, as used herein, is intended to refer to a row, column, or I/O, or group thereof (as might be found in a quadrant or other memory region or subcircuit) that might be repaired through a redundant, corresponding memory circuit. Similarly, the term “redundant memory element”, as used herein, is intended to refer to the redundant corresponding memory circuit that might be used to replace a memory element. The term “perpendicular”, as used herein, is intended to refer to orthogonal or otherwise separately addressable memory elements. For example rows are perpendicular memory elements to columns, and columns are perpendicular memory elements to rows. It should be noted that perpendicular memory elements may overlap, as rows and columns overlap to define an address space for a memory. Thus perpendicular as used herein does not in any manner imply exclusive of or exclusive from.

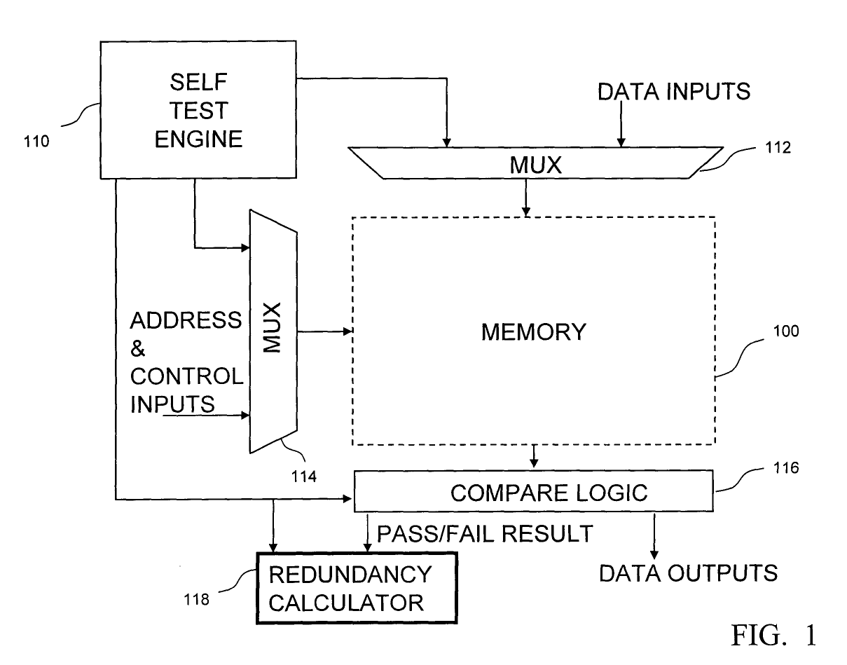

FIG. 1 is a block diagram illustrating the connections between an embedded memory and a memory self test system for calculating redundancy. The figure shows a conventional silicon memory which is embedded on a chip. The memory 100 may be a Static Random Access Memory (“SRAM”), Dynamic Random Access Memory (“DRAM”), or any other volatile or non-volatile memory suitable for self-test. The memory 100 may be surrounded by self-test logic to facilitate testing. Of course, the layout depicted in FIG. 1 is functional, and a physical realization of the built-in self-test circuitry need not literally surround the memory 100, however given the large and regular structure of many memories, this is not uncommon.

For each of the memory inputs there is a multiplexer 112 for data inputs from a self-test engine 110, and a multiplexer 114 for address and control inputs. The multiplexers 112, 114 allow inputs to the memory to be switched between normal operation and self-test stimuli. The stimuli is generated by the self-test engine 110. The self-test engine 110 also generates expect data which corresponds to outputs for a properly functioning memory. The expect data is compared with data coming out of the memory. Compare logic 116 performs the comparison and sends a pass/fail result to a redundancy calculator 118. When a fail is detected, i.e., when expect data does not match data out of the memory, information on the address location being exercised may be provided to the redundancy calculator 118 from the self-test engine 110.

In operation, the self-test engine 110 coordinates addressing of the memory and application of data to the memory inputs, while also coordinating reads from the memory and generation of expected outputs for comparison to the actual outputs.

It will be appreciated that each of the components depicted in FIG. 1 may be realized using a number of different fabrication techniques such as Complementary Metal Oxide Semiconductor (“CMOS”), Silicon on Insulator (“SOI”), or any other technique for physical realization of logic. It should also be appreciated that the components may be realized using a descriptive or high-level programming language such as Verilog or VLSI Hardware Description Language (“VHDL”), or as a net list or register transfer level description derived from such a language, or as physical layouts synthesized from abstract descriptions. The systems described herein are intended to include computer executable code used to functionally describe and simulate built-in self-test circuitry, as well as physical realizations of such functional descriptions, however obtained.

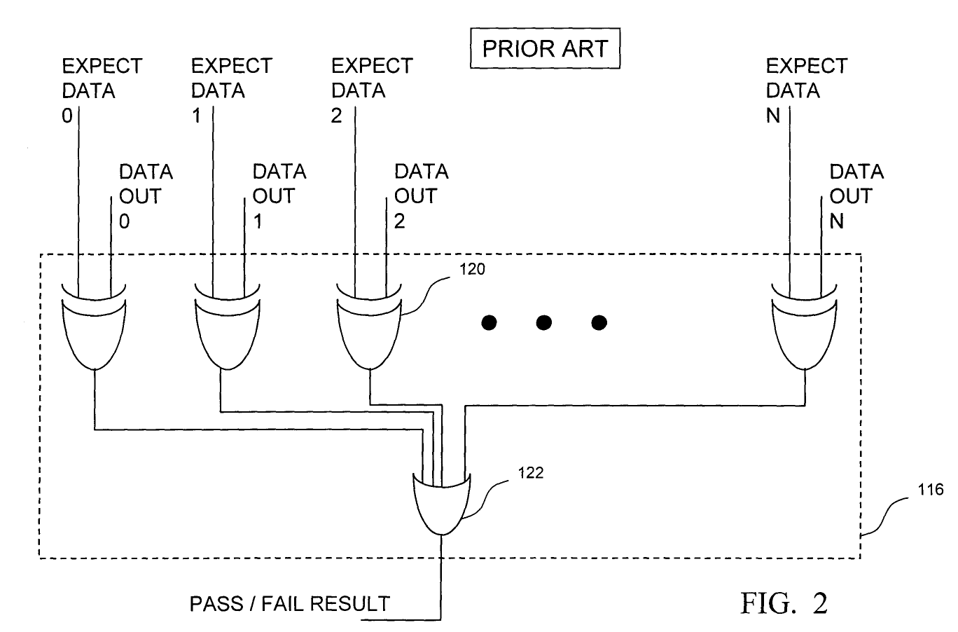

FIG. 2 is a logic diagram of a pass/fail comparator utilized in prior art to simultaneously test all data outs within a given memory word. The figure shows a detailed logic schematic for the prior art compare logic 116. Each memory data output is brought to the compare logic circuitry and provided as an input to a two-input XOR logic gate 120. The other input to the XOR gate 120 comes from the self-test engine 110. This other input provides the expect data to be compared against.

Whenever the data coming from the memory 100 and the expect data coming from the self-test engine 110 differ the XOR gate 120 provides a “1” output. The output of each XOR gate 120 is provided as input to a wide OR logic gate 122. Whenever one of the XOR gates 120 detects a difference, the output of the OR gate 122 becomes a “1”, indicating a fail was detected by the memory. This fail condition may be flagged and provided to the redundancy calculator 118 to help identify the appropriate redundancy replacement. If row-only redundancy is utilized then a fail would indicate that the associated row address need always be replaced by a redundant row element.

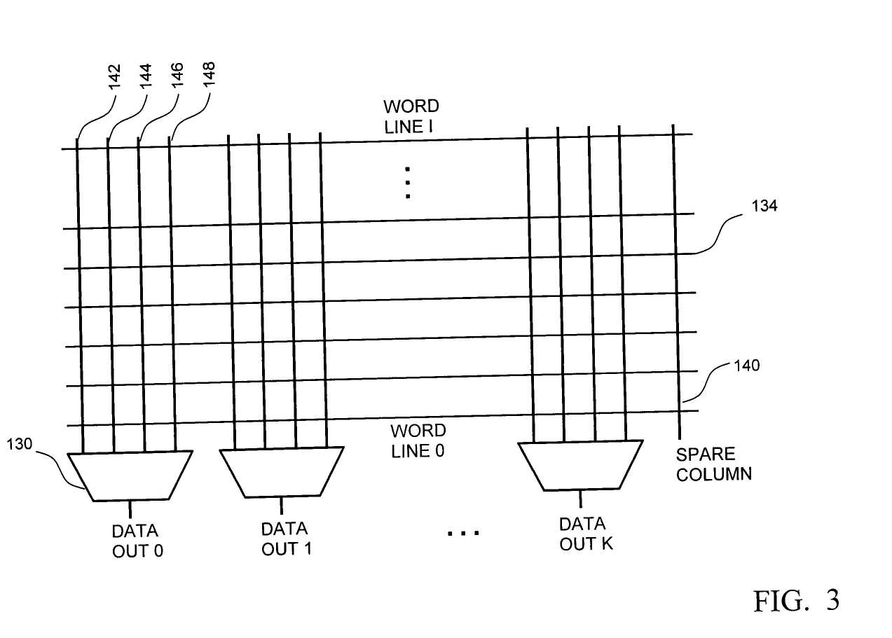

FIG. 3 shows a memory array composed of intersecting word lines and columns with a single redundant column displayed. The figure shows a memory, which may be, for example, the memory 100 depicted in FIG. 1, with one dimension of redundancy. The memory is composed of multiple rows or word lines 134. This memory is shown to include word lines zero through i. Further, the memory is composed of multiple columns 142, 144, 146, 148. Each data-out may have a mux 130 to select which of the columns associated with that data out is to be selected for a given read or write operation. A column address is specified to the memory and the column selects one column per data out. This memory is shown to include data outs zero through k. Each data out is shown to have four columns associated with it but this number can vary depending on the desired memory topology.

A spare or redundant column 140 is shown. This column can be used to replace any single column in a single data out mux. This redundant column can therefore repair a single cell fail, a vertically paired cell fail, a full column failure, or any other type of fail exclusively associated with a single column. It will be appreciated that, although a single redundant column is shown, multiple redundant columns may be included in a memory to repair distinct defects.

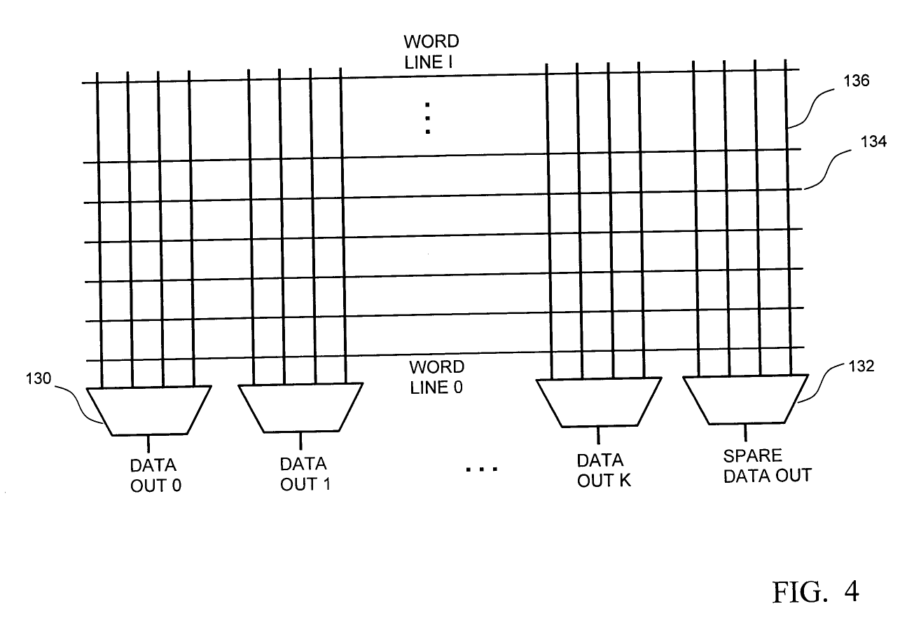

FIG. 4 shows a memory array with a redundant Input/Output (“I/O”). The figure shows a memory, which may be, for example, the memory 100 described above with reference to FIG. 1, with a spare or redundant data out. A complete set of spare columns and a spare data out mux 132 are included in the memory. Whenever a fail is detected in the memory that data out can be replaced by the spare data out. This configuration is often referred to as a redundant input/output or simply a redundant I/O. Any single cell failure, a paired vertical cell failure, a paired horizontal failure, a complete column failure, a paired column failure, or other failure affecting only memory elements associated with one I/O can all be repaired with a redundant I/O. Multiple redundant I/O can be included in a memory to repair distinct defects.

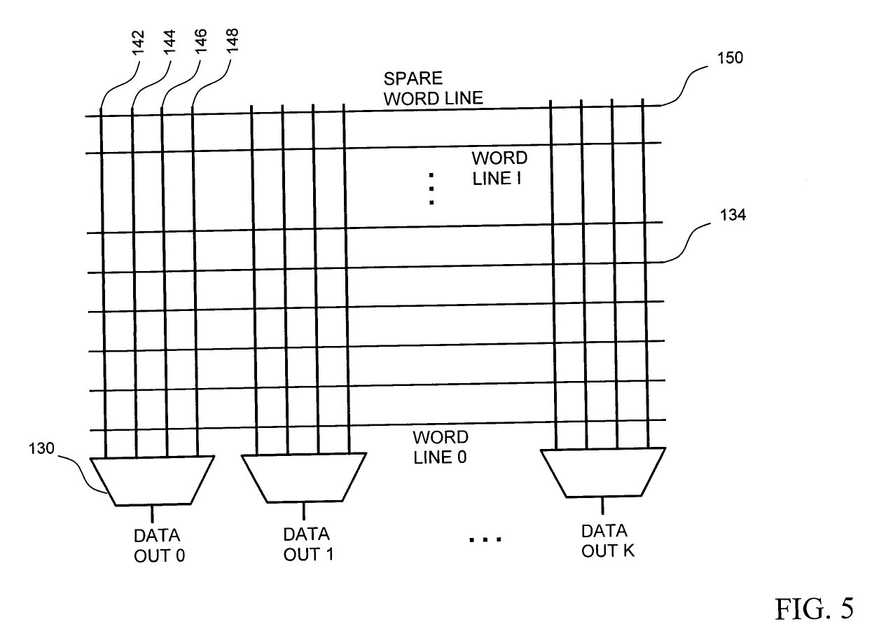

FIG. 5 shows a memory, which may be the memory 100 described above with reference to FIG. 1, with a redundant row. A spare word line 150 is included to replace a defective row. Defects that can be repaired by a redundant row include a single cell fail, a horizontally paired cell fail, a partial row failure, a complete row fail, or any other failure or group of failures associated with a single row. Multiple redundant rows can be included in a memory to repair distinct failures or vertically adjacent failures.

FIGS. 3 through 5 illustrate single dimensional redundancy implementations. These are useful for fixing single defects. However, memories may have multiple defects in various locations. These defects may be more effectively addressed with multiple dimensions of redundancy. One challenge of implementing built-in self-test is determining when to replace a defect with one dimension of redundancy versus another.

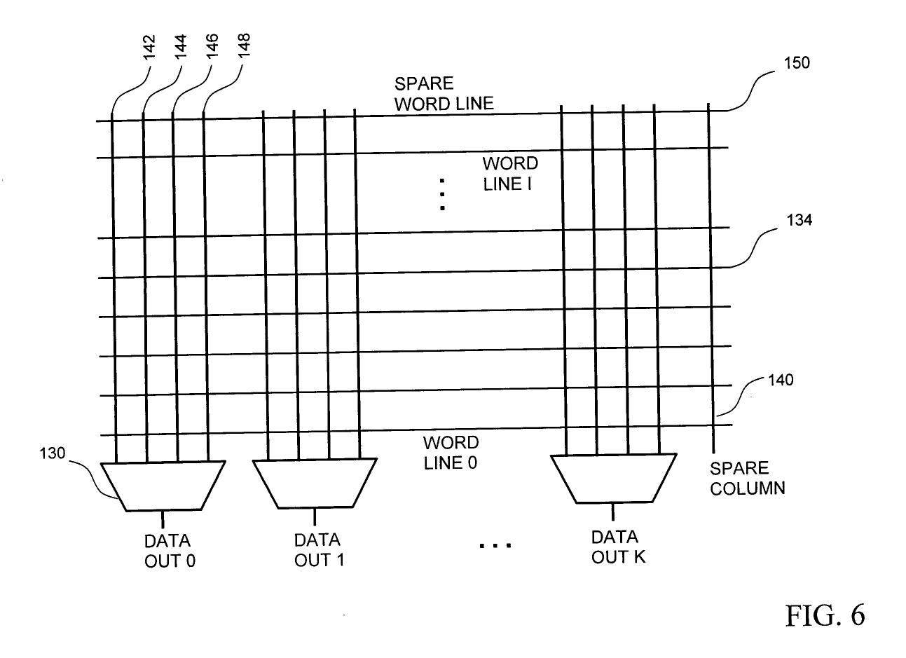

FIG. 6 shows a memory with two dimensions of redundancy where one dimension has one spare row while the other dimension has one spare column. Each spare element can replace the type defects described for FIGS. 5 and 3, respectively.

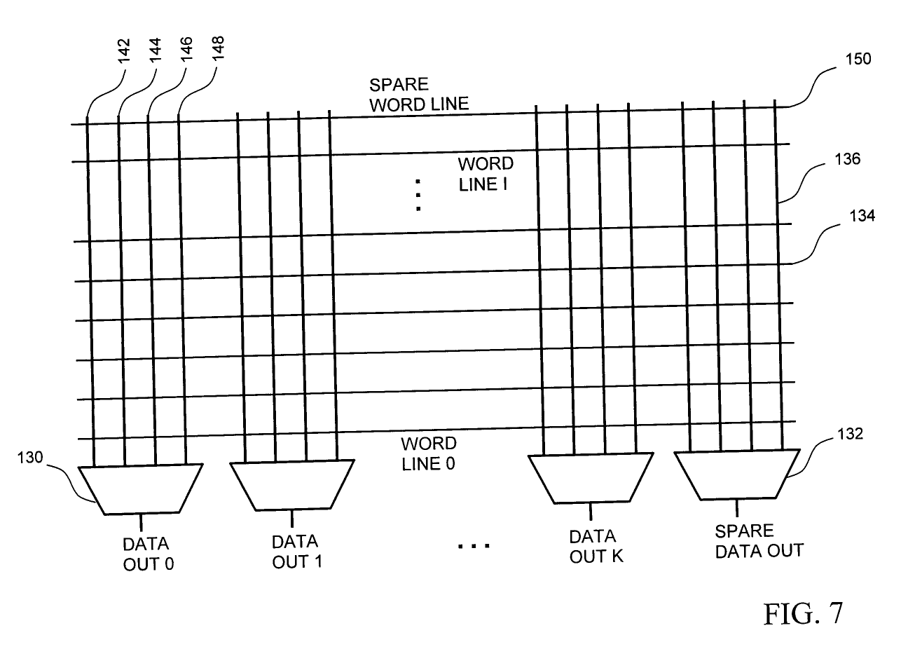

FIG. 7 shows a memory with two dimensions of redundancy where one dimension has a spare row while the other has a spare I/O. The types of defects that can be repaired are similar to those described for FIGS. 5 and 4, respectively.

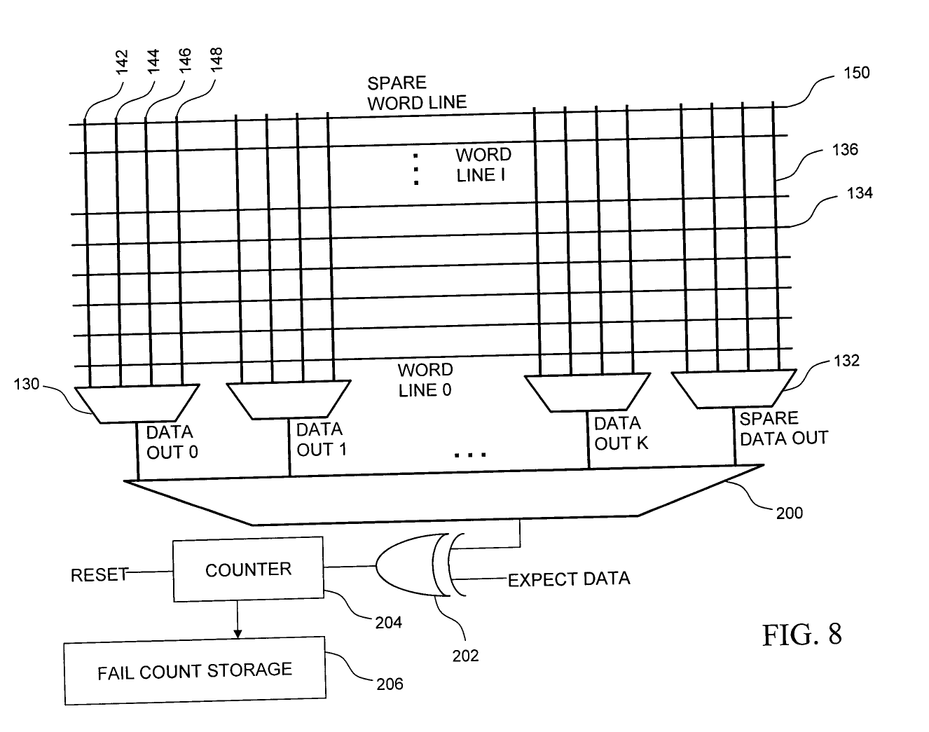

FIG. 8 shows a memory array with a redundancy calculator. The example shown assumes two dimensional redundancy where a spare row 150 and a spare data out are employed. In addition to a mux on the regular I/O 130 and the mux on the spare I/O 132, there may be a mux 200 that allows selection of a specific I/O 130 during redundancy calculation. There may be a single XOR logic gate 202 that performs logical comparison of the data coming out of the memory 100 with the expect data generated by the self-test engine 110. Further, there may be a counter 204 which counts the number of fails along a column or a full data out. A fail count storage 206 logic circuit may record a number of fails and the specific I/O 130 through which those fails were detected. In order to reduce storage requirements, the self-test circuitry may record only the number of fails for the I/O 130 with the largest number of fails, or an I/O 130 where a single column has more fails than the number of available redundant rows. After one I/O 130 has been tested a reset signal may be provided from the self-test engine 110 to reset the fail counter prior to testing the next I/O 130. Storage space for fail counts may be provided based on the total number of redundant I/O available for the memory 100 being tested.

It should be noted that by examining the output of XOR gate 202, a cycle-by-cycle pass/fail determination can be made. If this signal is sent off chip a full bit fail map can be generated detailing any fails in the memory. Based on the cycle number when the fail was detected, the exact bit that is defective can be identified. The resulting bit fail map may be used for diagnostics purposes.

It will be appreciated that the components depicted in FIG. 8 may be embodied in a number of different forms. The functions for each component may be performed by discrete logic, or by microcode, a programmable gate array, or other programmable or application specific integrated circuit. In certain embodiments, such as a hardware description language design of the self-test circuitry, or code executable by the self-test circuitry, one or more of the components may be realized as computer executable code. More generally, any integrated circuit techniques or technology may be adapted to use in self-test implementations provided they are suitably small in size to meet the design criteria of the memory being tested.

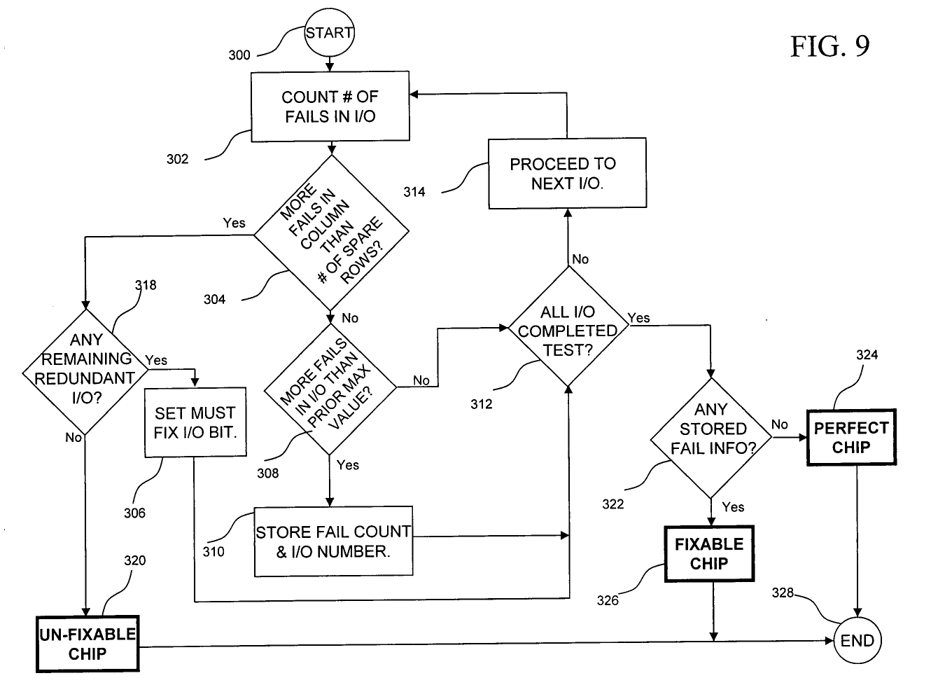

FIG. 9 is a flow chart showing how fail information may be stored for redundancy calculation. At the beginning 300, the test is started. The number of fails on a given I/O may be counted 302. During this counting, if a specific column is detected 304 to have more defects than the number of redundant rows then the I/O may be flagged. If there are remaining redundant I/O available 318 then the I/O may be specified to be repaired 306. If there are no available redundant I/O then the chip may be not be repaired and may be determined to be unfixable 320 or unrepairable.

If fewer fails are encountered than the number of redundant rows then the total number of fails in the I/O may be compared with any previously stored value of fail counts 308. If more fails are detected on the I/O currently under consideration then this I/O's number and the fail count may be stored 310. If this is not the case then it may be determined whether all of the I/O have completed test 312. If all have been tested then a determination may be made whether any fail information was stored during the test 322. If no fails were seen 324 then the chip may be perfect and requires no repair. If fails were seen then the chip is fixable and requires repair 326. The test may then be concluded 328.

If all of the I/O have not been tested then the I/O may be incremented 314 and the test may continue 302.

The example shown in FIGS. 8 and 9 assumes a redundant I/O. If a redundant column exists instead the same procedure can be utilized, storing the column number and total number of fails on that column rather than the number for an I/O. Another alternative for consideration is that each I/O can have an XOR compare gate 202. Mux 200 can then select which I/O's result to examine. The specifics possible depend on the unique aspects of the memory topology and associated design choices.

It will be appreciated that the order of steps described above with reference to FIG. 9 is an example only. The order of certain steps is arbitrary. For example, testing for spare redundancy 304 and testing for previous fail counts 308 may be performed in the opposite order, with suitable adjustments to the remainder of the logic flow. Furthermore, certain steps may be omitted, such as distinguishing between perfect and fixable chips 324, 326, or augmented, such as providing an error code with the designation of an un-fixable chip 320. All such variations and permutations are intended to fall within the scope of the systems described herein.

It will also be appreciated that it may be desirable to test the integrity of redundant memory elements before allocating them for repair. For a redundant column, for example, this may entail testing a redundant column to determine a number of failing bits and determining if any of the columns in memory have a number of fails that is greater than the number of failing bits in the redundant column. Such a column may be productively replaced with the redundant column in a multi-dimensional memory where redundant rows will be subsequently employed for repair.

Thus, while the invention has been disclosed in connection with the preferred embodiments shown and described in detail, various modifications and improvements thereon will become readily apparent to those skilled in the art. Accordingly, the spirit and scope of the present invention is to be limited only by the following claims.

1. A method for repairing defective memory elements in a memory having a plurality of memory elements including a first memory element and a second memory element, the method comprising:
counting fails in the first memory element with a counter;
counting fails in the second memory element with the counter; and
allocating a redundant memory element to replace the one of the first memory element and the second memory element having the most fails.

2. The method of claim 1 further comprising counting fails in each additional memory element of the plurality of memory elements with the counter.

3. The method of claim 1 further comprising selectively associating each one of the plurality of memory elements with the counter and counting the fails in that memory element.

4. The method of claim 2 wherein the memory includes a plurality of redundant memory elements, the method comprising allocating each one of the plurality of redundant memory elements to a one of the plurality of memory elements having the most fails.

5. The method of claim 4 wherein the memory is identified as unrepairable when the number of memory elements having fails exceeds the number of redundant memory elements.

6. The method of claim 1 wherein the redundant memory element does not replace the first column or the second column if no fails are counted in the first column and the second column.

7. The method of claim 1 wherein the plurality of memory elements include a plurality of columns and the redundant memory element includes a redundant column.

8. The method of claim 1 wherein the plurality of memory elements include a plurality of rows and the redundant memory element includes a redundant row.

9. The method of claim 1 wherein the plurality of memory elements includes a plurality of input/outputs and the redundant memory element includes a redundant input/output.

10. The method of claim 2 wherein the memory further comprises a second plurality of redundant memory elements perpendicular to the plurality of redundant memory elements, the method comprising designating one of the memory elements as a must fix memory element if a number of fails for that one of the memory elements exceeds a number of the second plurality of redundant memory elements available for allocation.

11. The method of claim 10 wherein the plurality of redundant memory elements includes columns and the second plurality of redundant memory elements includes rows.

12. The method of claim 1 further comprising allocating a perpendicular redundant memory element to repair any defects not repaired by the redundant memory element.

13. A method according to claim 1 wherein the plurality of redundant memory elements include a plurality of columns and the redundant memory element includes a redundant column, the method further comprising:
testing the redundant column to determine a number of failing bits;
determining if the redundant column has less fails than a one of the plurality of columns with the greatest number of failing bits; and
allocating the redundant column to replace the one of the plurality of columns with the greatest number of failing bits if the redundant column has fewer failing bits.

14. The method of claim 1 wherein the steps of the method are performed when power is applied to the memory.

15. A computer program product embodied in a computer readable medium for repairing defective memory elements in a memory having a plurality of memory elements including a first memory element and a second memory element, the computer program product comprising:
computer executable code for counting fails in the first memory element with a counter;
computer executable code for counting fails in the second memory element with the counter; and
computer executable code for allocating a redundant memory element to replace the one of the first memory element and the second memory element having the most fails.

16. An apparatus comprising:
a memory having a plurality of memory elements;
a redundant memory element suitable for replacing at least one of the plurality of memory elements;
a self-test circuit that tests the memory and allocates the redundant memory element to one of the plurality of memory elements if a defect is found, the self-test circuit including a multiplexer that selectively couples memory outputs to a fault counter that counts fails in each one of the plurality of memory elements tested by the self-test circuit.

17. The apparatus of claim 16 further comprising a fault count storage that stores numbers of fails and address information for one or more memory elements containing fails detected during a self-test.

18. The apparatus of claim 16 wherein the plurality of memory elements include at least one of a row, a column, or an input/output.

19. The apparatus of claim 16 further comprising a second fault counter that counts fails in a second plurality of memory elements perpendicular to the plurality of elements, the second fault counter selectively coupled to memory outputs by a multiplexer.

20. The apparatus of claim 16 further comprising a reset signal provided to the fault counter after testing of each memory element.

21. The apparatus of claim 16 wherein the self-test circuit allocates one or more redundant rows after allocating at least one of redundant columns or redundant input/outputs.

22. The apparatus of claim 16, wherein the apparatus is provided within an embedded memory of an integrated circuit.

23. An apparatus for repairing a memory comprising self-test circuitry for testing a plurality of memory elements, the self-test circuitry including a multiplexer and fault detection circuitry, the multiplexer selectively coupling an output from one of the plurality of memory elements to fault detection circuitry during a self-test.

24. The apparatus of claim 23 wherein the fault detection circuitry includes an exclusive-or logic gate that compares a memory output to an expected memory output.

25. The apparatus of claim 23 wherein the fault detection circuitry includes a counter for counting fails within a memory element under test.

26. The apparatus of claim 25 wherein the self-test circuit provides a reset signal to the counter after testing each one of the plurality of memory elements.

27. The apparatus of claim 23 wherein the fault detection circuitry includes storage for storing fail data including a location of one of the memory elements and a number of fails detected for the one of the memory elements.

28. The apparatus of claim 23 wherein fault data is provided to an external device.

29. The apparatus of claim 28 wherein the fault data includes a full bit fail map.
